(19) United States
(12) Patent Application Publication
(10) Pub. No.: US 2010/0075057 A1
(43) Pub. Date: Mar. 25, 2010

(54) HYDROPHOBIC AND SCRATCH-RESISTANT PAINTS FOR METAL SURFACES AND BRAKE DUST-REPELLING WHEEL COATINGS

(75) Inventors: Hartmut Krannich, Obergriesbach (DE); Reiner Mehnert, Markkleeberg (DE); Judith Reiser, Stuttgart (DE); Susanne Jericke, Sindelfingen (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/595,063

(22) PCT Filed: May 5, 2008
(86) PCT No.: PCT/EP08/03589

§ 371 Date: Oct. 8, 2009

(30) Foreign Application Priority Data
May 4, 2007 (DE) 10 2007 020 978.0
Nov. 6, 2007 (DE) 20 2007 018 435.2

(51) Int. Cl. C08L 83/04; B05D 3/02

(52) U.S. Cl. 427/387; 524/588

(57) ABSTRACT

The invention relates to hydrophobic and scratch-resistant paints, particularly for coating metal surfaces, comprising: A) organic binders having free —OH groups, B) network formers, which during the curing process of the liquid coatings form an inorganic silicate network made of mixtures of (B1) partially hydrolyzed and partially polycondensated organosilazane mixtures, and (B2) partially hydrolyzed and partially polycondensated organosilane mixtures, C) polysiloxanes having free —OH groups, aqueous solvent, and additives.

The invention relates to hydrophobic and scratch-resistant paints, especially for coating metal surfaces and finishings on motor vehicle wheels, wherein the finishing comprises an organic binder component, an inorganic network component which results during the curing from organosilazane/organosilane mixture precursors and results in an improvement of the mechanical properties, and comprises a hydrophobization component based on polypolysiloxane. Brake dust-repelling coatings of aluminum or light metal rims in the vehicle manufacture are especially affected.

Light metal rims are usually provided with a finishing in the manufacturing process, which usually consists of a pretreatment of the aluminum, a primer, a pigmented base paint and a clear paint layer.

The usual finishings generally do not have the necessary scratch-resistance to ensure permanent brilliance with regard to the cleaning of the aluminum rims with abrasive means such as brushes or rinsing sponges or the influence of snow chains.

The contamination of the wheel rims is a further problem. On the one hand, they are subjected to the source of permanently newly forming brake dusts in the form of disk brake devices, and on the other hand rims can only be cleaned with difficulty due to their geometry. The brake dusts however adhere comparatively well to the usual paint surfaces and are optically very noticeable due to their black coloration.

Hydrophobic paints are often used to reduce the adherence. Conventional paints thereby usually have hydrophobization additives of perfluorinated organosilanes, silicone oils, polydimethyl siloxanes or modified siloxanes. During the curing of the fluid coatings, these additives are not changed chemically and are also not bound into the polymeric network. The additives uncompatible with the polymer matrix diffuse to the surface of the coating over time and are finally passed to the environment of the coating. This process can be measured clearly by the increase of the surface energy of such a coating during an accelerated weathering, e.g. in the xeno test according to ISO 11 341. The effectiveness of many of these additives already decreases strongly after 250 to 500 hours of accelerated weathering. The surface energy increases to a value which is characteristic for the coating without hydrophobization additive. This type of the hydrophobization of coatings is thereby only suitable in a limited manner for surfaces with outside uses.

If an outside use of the finishing is aimed for as e.g. in the area of automobiles, the hydrophobization effect should endure possibly for years under real weathering conditions and mechanical strain. This requires a high measure of scratch-resistance especially for wheel coatings.

Lately, hydrophilic paint systems for rim coatings are also known. From DE 10 2004 001 288 A1 are known hydrophilic coatings for surfaces, especially for anti-fogging equipment for mirrors, vehicle headlights etc. which contain one or several polysilazanes and an ionic reagent or mixtures of ionic reagents. The polysilazane is a polysilazane of the formula —(SiR′R″—NR′″)ₙ, especially a perhydropolysilazane (R′═R″═R′″═H). The ionic reagent is preferably a salt of a carboxylic acid, especially a hydroxy carboxylic acid, or a cationic or anionic silane or an oligomer or polymer.

A further coating based on perhydropolysilazanes is known from DE 102004011212 A1. One or several co-binders, of polysilazane of the formula —(SiR′R″—NR′″)ₙ or of cellulose derivatives, polyesters, phenol or melamine resins, acrylates, epoxys, or polyisocyanates are preferably added. The finishing is especially suitable as protective coating for rims, especially aluminum rims.

From DE 102004011213 A1 are also known hydrophilic self-cleaning protective layers, especially for car rims, which have super hydrophilic, transparent and photocatalytic properties. The coating is based on polyperhydrosilazanes of the general formula —[Si(H)₂—N(H)—]ₙ. They also still contain photocatalytically active TiO₂, which leads to an oxidative attack on the dirt deposits.

From DE 10 2004 059 152 A1 are known anti-adhesively-acting coating compositions with a high temperature resistance, for example for anti-adherence inner linings of ovens or “easy-to-clean” coatings in the area of hot plates. The coating solutions are mixtures of metal and/or semi-metal alkoxides, functionalized or non-functionalized organosilanes of the general formula R²ₓSi (R³)₄₋ₓ and fluorinated or perfluorinated polymers and/or organosilanes with fluorine-containing side chain.

From U.S. Pat. No. 5,780,530 are known coatings for different outer uses, which comprise thermally crosslinking resins with the components (a) coating-forming polyol-forming resins, (b) binders, especially on the basis of blocked polyisocyanates and aminoplast resins and (c) ultrafine silicate particles, especially of the hydrolysis and polycondensation of tetramethyl orthosilicate (TMOS) and (d) catalysts.

The known finishings partially have a dirt-repellent effect which is too low or partially a scratch-resistance which is too low. The listed Special Si polymers are additionally usually comparatively expensive.

It is thus the object of the invention to provide an economical paint or coating for the formation of dirt-repellent and scratch-resistant finishings, especially a paint for applying to light metal rims, and to show a dirt-repellent and scratch-resistant finishing on motor vehicle wheels.

The object is solved according to the invention by a hydrophobic and scratch-resistant paint, especially for coating metal surfaces, containing
(A) organic binders having free —OH groups,
(B) network formers, which during the curing process of the liquid coatings form an inorganic silicate network made of mixtures of
(B1) organosilazane mixtures,
(B2) organosilane mixtures,
(C) polysiloxanes having free —OH groups, solvent,
additives with the characteristics of claim 1.

Further solutions of the object according to the invention are present in a method for producing a finishing comprising the following steps,
applying the paint by means of coating or spray methods,
air drying of the paint layer,
baking the paint at a temperature of 130 to 180° C. under polycondensation of the organosilazane and organosilane mixture (B) and co-condensation with the polysiloxanes (C) with the characteristics of claim 18,
   and a finishing on motor vehicle wheels for reducing the brake dust adherence, comprising an organic binder component, a polycondensated organosilazane/organosilane mixture which forms an inorganic silicate network and acts as scratch-resistant component and hydrophobization means and a hydrophobization component based on alkyl or aryl polysiloxane, wherein the three components are bound to each other in an essentially covalent manner, that is, via —Si—O—Si bridges, and the hydrophobization component is enriched at the paint surface and is present in an immobilized manner against discharge from the surface.

The first aspect of the invention thus comprises a paint for a hydrophobic dirt-repellent and scratch-resistant finishing, which comprises as essential components organic binders, a organosilazane/organosilane mixture as precursor for an inorganic siliceous network, and a reactive hydrophobization additive. The siliceous network of the finishing has thereby the properties of a hydrophobic scratch-resistant component. The paint further contains solvents and additives usual for paint.

It is of essential importance for the paint that the components are chosen in such a manner that, with the finishing, a chemical binding of the hydrophobization additive (C) to the inorganic siliceous network (B) placed in the organic binders (A) can take place. This siliceous network are meant to be the polycondensation products of the component (B), which are formed by polycondensation between (B1) and (B1), (B2) and (B2), and between (B1) and (B2). These are for example the polycondensation products of partially hydrolyzed polymethyl (hydro) polysilazane and alkoxy or aryloxy silanes. The covalent binding of the hydrophobization additive thereby takes place via the hydroxyl groups of the inorganic siliceous network with the free and reactive OH-groups of the hydrophobization additive. Additionally, a binding to free and reactive OH- and/or NH-/NH₂-groups of the organic binder takes place additionally in the finishing.

The organic binders can also be co-crosslinked with the partially hydrolyzed, and the partially condensated or precondensated components (B1) and/or (B2) due to reactive OH and/or NH-/NH₂-groups, especially the polycondensation products of polymethyl (hydro) polysilazane/alkoxy or aryloxy silane mixtures, whereby the scratch-resistant component is firmly bound into the organic binder system.

A first component (A) of the paint according to the invention are organic binders with free —OH groups. This can for example be polymerization resins or condensation resins, for example aminoplasts, especially urea and melamine formaldehyde resins, alkyd resins, acryl resins, polyester or modified polyesters, epoxys, polyisocyanates or blocked polyisocyanates or polysiloxanes.

Especially preferred organic binders (A) are formed of urea and melamine formaldehyde resins, alkyd resins, acryl resins, polyesters or modified polyesters, epoxy resins, polyisocyanates and/or acrylates, especially the systems acrylate/melamine, polyester/melamine, alkyd/melamine, or self-crosslinking acrylate and epoxy resins, which comprise a part of free OH-groups or OH- and NH/NH₂-groups. Free OH- and/or NH-/NH₂-groups can be those OH- and/or NH-/NH₂-groups which serve for the crosslinking/curing of the organic binder, as also further OH and/or NH-/NH₂ groups which do not directly take part at the binder curing. As the OH- and/or NH-/NH₂-groups are possibly withdrawn from the binder curing reaction by crosslinking with the scratch-resistant component, or the component (B), a corresponding excess of OH-group-containing binder components has to be provided with these paints.

A second component (B) of the paint according to the invention are mixtures of partially hydrolyzed and partially condensated polyalky (hydro) polysilazanes (B1) and partially hydrolyzed and partially condensated alkoxy or aryloxy silanes (B2), which are suitable for the formation of an inorganic siliceous network, which results by their polycondensation.

The non-condensated alkyloxy or aryloxy silanes as a precursor for the component (B2) is tetraorganyloxy silanes (also called organosilanes in short) of the general formula Si(OR¹)₄. R¹ are organic residues. R¹ preferably, represents alkyl and/or aryl residues independent of each other. R¹ stands especially preferred for branched or unbranched C₁- to C₈ alkyl residues, especially methyl, ethyl, n-propyl, i-propyl and/or n-butyl residues. Tetraethyl orthosilicate and tetramethyl orthosilicate are amongst the especially preferred tetraorganyloxy silanes.

These precursors are especially converted with water by acid- or base-catalyzed reaction, wherein initially the hydrolysis and then, with progression of the reaction, increasingly also condensation result in the partially hydrolyzed and partially condensated componets (B2).

The partial or polycondensation known especially from the sol-gel chemistry takes place in two steps. Initially, a hydrolysis, especially an acid-catalyzed hydrolysis takes place in an aqueous medium, wherein the organic residues are split off partially and silanole groups result. In a subsequent step, a condensation takes place via the silanole groups. The components (B) are oligomeres, or lower polymeric connections of this hydrolysis/condensation reaction, which act as precursors for a [—Si—(O—)₂—O—Si—(O—)₂—O—]ₙ network. The partially condensated alkyloxy or aryloxy silanes can be described by the general formula [—Si(OR²)₂—O—Si(OR²)₂—O—]ₙ, wherein R² can represent R¹ or further partially condensated alkyloxy or aryloxy silane residues independent from each other.

In a preferred arrangement, mixing of organosiloxanes with tetraethoxysilanes (TEOS) or “anhydrolyzed” TEOS (e.g. DS 40 of Degussa Ag) are used as component (B2). These form an inorganic siliceous network (also —O—Si—O—Si— network) with the silanoles, which increases the resistance, or the scratch-resistance with regard to mechanical influences.

For the formation of the component (B1), which also occurs as a Si—O—Si network former, organopolysilazanes are used, which result by ammonolysis of dichlorine silanes (R²SiCl₂) and a following base-catalyzed dehydrating coupling in polymeric form.

The general scheme of the organopolysilazanes for R═CH₃ or R═CH═CH₂ is as follows:

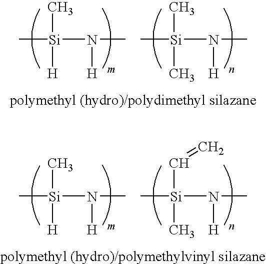

Short-chained alkyl residues or alkylene residues individually or in mixture are of special importance as a residue, especially methyl, ethyl or vinyl, n-propyl or propylene, iso-propyl, n-butyl or n-butylene, iso-butyl or iso-butylene, or tert.-butyl.

In a preferred arrangement, polymethyl (hydro)/polydimethyl silazanes are used, where the part of the dimethyl-substituted group is at 20-85%.

In a further preferred arrangement, polymethyl (hydro)/poylmethylvinyl silazanes are used, where the part of the methylvinyl-substituted group is at 10-30%.

The reaction scheme for the partial hydrolysis and partial condensation of the organosilazanes can be compared to the one of the alkylalkoxy silanes.

The underlying reactions of hydrolysis and condensation for the polydimethyl silazane group is:

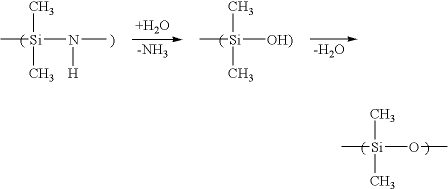

As a result of the hydrolysis step, reactive silanoles or silicones result, which can react with OH-groups of other paint components. It is hereby of decisive importance that these silanoles or silicones also react very well with the component (B2) and that a permanent anchoring in the —O—Si—O—Si— network of the finishing takes place. The part of polymethyl hydrosilazanes is suited especially well for condensating into the siliceous network. The silanoles or silicones have a highly hydrophobizing effect on the paint and contribute thereby considerably to the dirt-repellent function on wheel finishings.

In a preferred arrangement, the weight part at the component (B) at the sum of the reactive components (A)+(B)+(C) in the paint is 5 to 50 weight %. A content of 10 to 40 weight % is preferably adjusted.

The O—Si—O—Si— network is formed via the given silicium-organic precursors during the thermal crosslinking of the fluid coating material or paint. It is mechanically and/or chemically bound into the organic network. It thereby still contains a sufficient concentration of silanole groups, which can react with surface additives OH-terminated on one side e.g. by condensation.

A third component (C) of the paint is formed by linear and/or annular polysiloxanes. They comprise the general formula R³([—Si(R³)₂—O—]ₙ—X, which shall also be valid for the special case of silsesquioxanes [(R³,X)—SiO_{3/2}]ₙ. Thereby, R³ stands independently from each other for alkyl or aryl residues, corresponding to the designation R¹ implemented above, or also for fluorinated or perfluorinated alkyl or aryl residues. X stands for —Si(R⁴)₃ or —Si(R³)(R⁴)₂ or —Si(R³)(R⁴)₂, wherein R⁴ stands for hydroxyalkyl or hydroxyaryl residue.

R⁴ stands especially for branched or unbranched C1 to C8 hydroxylalkyl residues or dihydroxylalkyl residues, especially hydroxymethyl, hydroxyethyl or dihydroxypropyl residues.

In a preferred arrangement, C5- to C20-polydimethyl siloxanes are used as R³. The end group in α-position is hereby preferred —Si(R³)₂(R⁴) with R³=methyl or ethyl and R⁴=—CH₂OH or —CH₂—CH₂—OH.

The end groups X have multiple alcohols in a further arrangement, especially one or several residues R⁴ are formed by C3- to C5-alkyldioles or glycerin.

With the fluorinated alkyls, especially only the end group is fluorinated or perfluorinated in the ω-position. For example, an α-methoxy-ω-trifluoromethyl-polydimethyl siloxane can be used.

With the aryl-containing polysiloxanes, preferably only the end group in the ω-position carries one or several aryl substituents, especially phenyl, methylphenyl or toluoyl substituents, while the further residues R³ represent alkyl residues, especially methyl or ethyl residues.

The polysiloxanes (C) preferably have an average chain length in the region of n=6 to n=30 or an average molecular weight of 200 to 80,000 g/mol. Only polysiloxanes with the same chain length, especially with a chain length of 8 to 20 are used in an especially preferred manner.

The polysiloxanes (C) are also mainly bound chemically in the inorganic and the organic network. The inorganic siliceous network thereby still contains a sufficient concentration of silanole groups, which can react with OH-terminated polysiloxanes on one side, but also other surface additives e.g. by condensation.

The paints can be applied well to substrates of plastics, metals or painted surfaces. An application to the metal rim or also on a rim provided with a base paint is thus possible.

Especially good coatings are achieved on metal surfaces if the metal surface carries a nano or micro layer of a firmly adhering metal oxide.

It is especially advantageous to anodize aluminum/aluminum alloy surfaces prior to the coating to form a firmly adhering Al₂O₃ layer.

A further aspect of the invention relates to the method for processing the paint according to the invention. The essential process steps are thereby
the application of the paint by means of dip coating, coating or spraying methods,
the air drying the paint layer and
the baking of the paint at a temperature of 130 to 180° C. with polycondensation of the partially condensated siloxanes (B) and co-condensation with the polysiloxanes (C).

The usual coating and spraying methods and dip coating are suitable as application methods. The suitable consistency of the paints is thereby advantageously adjusted by the condensation degree or the molecular weight of the scratch-resistant components (B).

The freshly applied paint layer is initially dried in the air. The temperature is thereby kept so low that no noticeable condensation takes place between the components (B) and (C). The organic solvent preferably evaporates with regard to the water during this phase, whereby the dissolving power for the component (C) reduces. These components enrich at the surface in the fluid coating material and thus effect a reduction of the surface energy of the cured coating material. The enrichment of the component (C) acting as hydrophobizating component in the surface layer of the finishing considerably increases the dirt-repellent effect of the finishing.

The polycondensation of the components (B) and especially the condensation between (B) and (C) only takes place in the following step of the baking of the paint. The hydrophoby remains anchored evenly and firmly in the depth of the finishing by the component (B1) firmly bound in the network.

A temperature in the region of 110 to 210° C. is chosen for the baking. The temperature thereby also has to be adjusted to the boiling temperature of the alcohols freed by the hydrolysis reaction of the component (B). If polymethyl (hydro) polysilazane/tetraethyl orthosilicate is chosen as starting substance for the component (B), the temperature is preferably at 150 to 180° C.

An essential advantage compared to the conventional paint coatings is the rigid covalent binding between the hydrophobization additives and the further components of the paint, especially with the scratch-resistant component and the silanoles firmly bound in the siliceous network, or polysiloxanes of the components (B1). It is advantageous that the methyl-substituted organosilazanes result in a Si—O—Si— network with hydrophobic properties after hydrolysis and condensation. This is a result of the spherical arrangement of methyl groups at the network surface.

After the baking, a finishing is present with an organic binder component, a polycondensated polymethyl (hydro) polysilazane/alkoxy or aryloxy silane scratch-resistant component which forms a [—Si(O—)₂—O—Si(O—)₂—O—) network, and with a hydrophobization component based on alkyl or aryl polysiloxane. The three components are essentially bound in a covalent manner to each other via —Si—Si— bridges and the hydrophobization component is enriched at the top side of the paint and immobilized. As the Si—O—Si— network is bound macroscopically into the binder phase generated by the organic binder system, a chemical anchoring of the hydrophobization additive is achieved. The surface additive also remains effective in the polymeric network. Its diffusion through the organic network is excluded by the fixing at the Si—O—Si— network. A depletion by diffusing out or washing out is virtually impossible. The permanent hydrophobizing of organic layers according to the invention is achieved.

The content of non-covalently bound hydrophobization components based on polysiloxane is typically reduced to below 0.01 weight %.

### EXAMPLE 1

For the principal representation of the hydrophobizing effect of the component B1, a mixture of 19 mass % polymethyl (hydro) polysilazane/polydimethyl silazane with a dimethyl silazane part of 33% (ML33), 5 mass % of precondensated tetraethoxysilane (DS 40), 15 mass % of a melamine resin/acrylate binder and 1 mass % of a hydroxy (polyethylene oxy propyl terminated polydimethyl siloxane (MCR-C13, Gelest Inc.) was laced with 60 mass % butyl acetate as solvent and stirred vigorously with a dissolver for about 5 minutes. The mixture was applied by spraying and then cured for 20 minutes at 180° C. The cured finishing had a water contact angle of about 102° and a surface energy of about 21 mN/m, while a water contact angle of about 90° was measured for the original melamine/acrylate paint without ML33 and a surface energy of about 33 mN/m. A comparatively high water contact angle and also low surface energy show highly hydrophobic surface properties of the coating with component B1 compared to the original coating. The water contact angle with the goal application of the dirt-repellent coatings on vehicle wheels has thereby higher importance than the surface energy.

The influence of the component B was examined by means of comparison experiments for different paint compositions I to VI with regard to the water-repellent effect. The approach is as described in example 1.

In table 1 are shown the compositions of different paints and the water contact angles and surface energies of the corresponding coatings for comparison experiments.

It is thereby:

ML33: polymethyl (hydro) polysilazane/polydimethyl silazane with a dimethyl silazane part of 33%,

### Dimethyl-Silazan ML85:

polymethyl (hydro)/polydimethyl silazane with a dimethyl silazane part of 85%, methylvinyl silazane VL20:
polymethyl (hydro)/polymethylvinylsilazan with a methylvinyl silazane part of 10-30%, polysiloxane MCR-C13: a typical hydrophobilizating polysiloxane TEOS: non-hydrolyzed tetraethyl orthosilicateDS 40: partially hydrolyzed and oligomerisated TEOS

TABLE 1

| Sample name | I | II | III | IV | V | VI |
|---|---|---|---|---|---|---|
| Dimethyl | 1 | 1 | 1 | — | — | — |
| silazane | | | | | | |
| ML33/C33 | | | | | | |
| Dimethyl | — | — | — | 1 | — | — |
| silazane ML85 | | | | | | |
| Methylvinyl | — | — | — | — | 1 | — |
| silazane VL20 | | | | | | |
| Polysiloxane | — | — | — | — | — | 1 |
| MCR-C13 | | | | | | |
| TEOS | 10 | — | 10 | 10 | 10 | — |
| Partially | — | 10 | — | — | — | 10 |
| hydrolyzed | | | | | | |
| TEOS DS 40 | | | | | | |
| Organic | 73 | 73 | 73 | 73 | 73 | 73 |
| binder | | | | | | |
| Ethanol | 16 | 16 | 16 | 16 | 16 | 16 |
| Water contact | 92° | 90° | 92° | 93° | 89° | 86° |
| angle | | | | | | |
| Surface energy | 28 | 34 | 29 | 28 | 33 | 30 |
| (in Nm/m) | | | | | | |

It can be seen from the comparative values that the coatings with silazane components (experiments I to V) have consistently high water contact angles compared to the silazane-free sample VI. The measuring values of the surface energy show values below the comparison sample VI at least for the samples I, III and IV.

For wheel coatings, the following sealing paint without organic binder has for example stood the test of time, which can also be applied to baking paint or powder paint already cured:

| Component | Part in Ma % |
|---|---|
| Organosilazane ML33/C33 | 20 |
| Partially hydrolyzed TEOS DS40 | 9 |
| OH-terminated polysilane | 1 |
| Surface energy of the cured coating | 20.7 mN/m |

The following paint with organic binders has for example stood the test of time as baking paint on wheels:

| Component | Part in Ma % |
|---|---|
| Organosilazane ML33/C33 | 19 |
| Partially hydrolyzed TEOS DS40 | 5 |
| OH-terminated polysilane | 1 |
| Organic binder | 15 |
| Solvent butyl acetate | 60 |
| Surface energy of the cured coating | 21 mN/m |

1. A paint for providing a hydrophobic and scratch-resistant coating, the paint comprising:
reactive ingredients
(A) organic binders having free —OH-groups,
(B) network formers, which, during the curing process of the liquid paint to form the coating, form an inorganic silicate network made of mixtures of
(B1) partially hydrolyzed and partially polycondensated organosilazane mixtures, and
(B2) partially hydrolyzed and partially polycondensated organosilane mixtures,
(C) polysiloxanes having free —OH groups,
aqueous solvent, and
additives.

2. The paint according to claim 1, wherein the organic binders (A) and the partially condensated alkyloxy or aryloxy silanes (B2) contain reactive ethylenic unsaturated groups, especially vinyl and/or (meth)acrylate groups.

3. The paint according to claim 1, wherein the partially hydrolyzed and partially condensated organosilazane mixtures are produced of polyalky (hydro) polysilazanes.

4. The paint according to claim 1, wherein the weight part of the partially condensated alkyloxy or aryloxy (B) at the sum of the reactive components (A)+(B)+(C) is 5 to 50%.

5. The paint according to claim 1, wherein the weight part of the polysiloxanes (C) at the sum of the reactive components (A)+(B)+(C) is 0.5 to 25%.

6. The paint according to claim 1, wherein the non-condensated alkyloxy or aryloxy silanes have the general formula Si(OR¹)₄, wherein R¹ represent independent from one another alkyl and/or aryl residues.

7. The paint according to claim 5, wherein the partially condensated alkyloxy or aryloxy silanes comprise the general formula [—Si(OR²)₂—O—Si(OR²)₂—O—]ₙ, wherein R² can represent independent of each other R¹, or partially condensated alkyloxy or aryloxy silane residues.

8. The paint according to claim 6, wherein the ratio of [silanol and partially condensated alkyloxy and aryloxy silane residue] to [alkyl and aryl residue] is above 30 with the substituent R².

9. The paint according to claim 1, wherein the partially condensated alkoxy or aryloxy silanes (B) comprise a mean molecular weight of 200 to 80,000 g/mol.

10. The paint according to claim 1, wherein the partially polycondensated organosilazane mixtures are produced of polyalkyl (hydro) polysilazanes, where the alkyl residues are chosen from methyl, ethyl or vinyl, n-propyl or propylene, iso-propyl, n-butyl, or n-butylene, iso-butyl, or iso-butylene, or tert-butyl.

11. The paint according to claim 1, wherein polymethyl (hydro)/polydime-thylsilazanes are used for the component B1, where the part of the dimethyl-substituted group is 20-85%.

12. The paint according to claim 1, wherein the polysiloxanes (C) comprise the general formula R³([—Si(R³)₂—O—]ₙ—X, wherein R³ are alkyl or aryl residues (R¹) or fluorinated or perfluorinated alkyl or aryl residues, and X=—Si(R⁴)(R⁴)₂—Si(R³)₂ or —Si(R³)₂(R⁴) with R⁴=hydroxyalkyl or hydroxyaryl residue.

13. The paint according to claim 5, wherein R¹ stands for branched or unbranched C₁- to C₈-alkyl residues, especially methyl, ethyl-, n-propyl, propyl and/or n-butyl residues.

14. The paint according to claim 12, wherein R³ stands for methyl or ethyl residues.

15. The paint according to claim 12, wherein R⁴ stands for branched or unbranched C₁- to C₈-hydroxyalkyl residues or dihydroyalkyl residues, especially hydroxymethyl, hydroxyethyl or dihydroxypropyl residues.

16. The paint according to claim 1, wherein the polysiloxanes (C) have an average chain length in the region of n=6 to n=30.

17. The paint according to claim 5, wherein the organic binders (A) consist of urea and melamine formaldehyde resins, alkyd resins, acryl resins, polyesters or modified polyesters, epoxy resins, polyisocyanates and/or acrylates, especially the systems acrylate/melamine, polyester/melamine, alkyd/melamine, or self-crosslinking acrylate and epoxy resins.

18. A coating comprising a paint coating a metal surface which carries a nano or micro layer of a firmly adhering metal oxide, wherein the coating is produced by the process of coating the paint of claim 1 onto the metal surface.

19. The coating of claim 18, wherein the metal surface is an anodized aluminum/aluminum alloy surface.

20. A method for the production of a finishing with a paint according to claim 1, comprising the following steps,
applying the paint by means of coating or spraying methods,
air drying the paint layer, and
baking the paint at a temperature of 130 to 180° C. with polycondensation of the partially condensated siloxanes (B) and co-condensation with the polysiloxanes.

21. A finishing on vehicle wheels adapted for reducing the brake dust adherence, comprising an organic binder component, a polycondensated alkyloxy or aryloxy silane scratch-resistant component, which forms a [—Si(O—)₂—O—Si(O—)₂—O—] network, a polycondensated organo-silazane component which is bound to the [—Si(O—)₂—O—Si(O—)₂—O—] network, and a hydrophobization component based on alkyl or aryl polysiloxane, according to claim 1, wherein the four components are essentially bonded in a covalent manner via —Si—O—Si bridges, and the hydrophobization component is present in an enriched and immobilized manner at the paint surface.

22. The finishing according to claim 21, wherein the content of hydrophobization components based on polysiloxane not bonded in a covalent manner is below 0.01 weight %.
